(19) United States
(12) Patent Application Publication
(10) Pub. No.: US 2011/0162956 A1
(43) Pub. Date: Jul. 7, 2011

(54) METHOD FOR SEPARATING RICH ORE PARTICLES FROM AGGLOMERATES WHICH CONTAIN NON-MAGNETIC ORE PARTICLES AND MAGNETIZABLE PARTICLES ATTACHED THERETO, ESPECIALLY FE-CONTAINING OXIDE COMPONENTS SUCH AS FE3O4

(76) Inventors: Vladimir Danov, Erlangen (DE); Werner Hartmann, Weisendorf (DE)

(21) Appl. No.: 13/063,091

(22) PCT Filed: Sep. 1, 2009
(86) PCT No.: PCT/EP09/61249

§ 371 Date: Mar. 9, 2011

(30) Foreign Application Priority Data
Sep. 18, 2008 (DE) 10 2008 047 854.7

(51) Int. Cl. B03C 1/015; C01G 3/12; B01J 19/08; B03C 1/32; B03C 1/30; B01J 19/10

(52) U.S. Cl. 204/157.42; 423/25; 422/186.01

(57) ABSTRACT

In a method for separating rich ore particles from agglomerates which contain said rich ore particles and magnetizable particles attached thereto, especially Fe3O4, in which agglomerates of the rich ore particle and the magnetizable particle are bonded by organic molecular chains, the agglomerates are contained in a suspension containing a carrier fluid and are broken up by an input of mechanical energy so that an agent contained in the suspension and decomposing the exposed, hydrophobic molecular chains can act upon the molecular chains. The Fe-containing oxide components are separated from the suspension in a magnetic separation process.

### CROSS-REFERENCE TO RELATED APPLICATIONS

This application is a U.S. National Stage Application of International Application No. PCT/EP2009/061249 filed Sep. 1, 2009, which designates the United States of America, and claims priority to DE Application No. 10 2008 047 854.7 filed Sep. 18, 2008. The contents of which are hereby incorporated by reference in their entirety.

### TECHNICAL FIELD

The invention relates to a method for separating ore particles of value, referred to hereafter for example as “Cu₂S”, from agglomerates which contain ore particles of value and magnetizable particles attached thereto, especially Fe-containing oxide components, such as Fe₃O₄, in the course of a process for extracting the ore of value from crude ore, within which particles the ore of value and the magnetizable particles are bonded by way of organic molecular chains. Suitable magnetizable particles are referred to hereafter by way of example as “Fe₃O₄”, which is intended in a representative sense and also includes other suitable compounds or alloys. Suitable ores of value are referred to hereafter by way of example as Cu₂S, which is intended in a representative sense and also includes other ores of value.

### BACKGROUND

Ores of value, such as for example copper sulfide (Cu₂S), are obtained by way of ore extraction. In order to separate the copper sulfide from the ore, the ore is first finely ground until it is in a virtually pulverulent form. Subsequently, in order to make magnetic separation of the Cu₂S possible, magnetite (Fe₃O₄) and agents containing other chemical additives which have a hydrophobizing effect on the Cu₂S and the Fe₃O₄ are added to the ore. This hydrophobization occurs as a result of the longer organic molecular chains that are contained in the additives and selectively become attached to the Cu₂S or the Fe₃O₄. The latter are consequently surrounded with a water-repellent shell. These organic molecular chains then bring about an organic bond between the Cu₂S and the magnetite, so as to produce Cu₂S/Fe₃O₄ agglomerates that are magnetic (unlike pure Cu₂S) and, as a result, can be separated from the rest of the fine powder, which substantially contains sand, by means of magnets. This means that these Cu₂S/Fe₃O₄ particles can be extracted as a whole from the remaining material.

Since, however, the Cu₂S and Fe₃O₄ particles are of a size that is in the μm range, they have a tendency to agglomerate, that is to say that relatively large, cluster-like agglomerates form from one or more Cu₂S particles and a multitude of Fe₃O₄ particles, the Cu₂S particles being bonded to the Fe₃O₄ particles by way of the organic molecular chains. Within this particle agglomerate, the Cu₂S particles are enclosed virtually completely by Fe₃O₄ particles; the organic molecular chains are situated between the Fe₃O₄ particles and the Cu₂S particles. So, to be able to separate the pure Cu₂S, it is necessary to break up this organic bond and to obtain the individual particles again, so that the Fe₃O₄ can once again be magnetically separated from the Cu₂S. This has previously been performed by chemical means, that is to say it is attempted to break down the molecular chains by a suitable chemical process. As a result of the virtually complete enclosure of the Cu₂S particles with Fe₃O₄ particles, there is the problem that the agents that are intended to react with the organic molecular chains can scarcely come into contact with these organic compounds for which reason the particle separation that can be achieved in this way is only relatively low.

### SUMMARY

According to various embodiments, a method can be provided which makes it possible to obtain better separation of the ore particles of value and magnetizable particles that are bonded as a result of hydrophobization.

According to an embodiment, in a method for separating ore particles of value from agglomerates which contain ore particles of value and magnetizable particles attached thereto, especially Fe₃O₄, in the course of a process for extracting the ore of value from crude ore, within which agglomerates the ore particles of value and the magnetizable particles are bonded by way of organic molecular chains, the agglomerates are contained in a suspension containing a carrier fluid and are broken up by introducing mechanical energy, so that an agent that is contained in the suspension and breaks down the exposed, hydrophobically acting molecular chains can act on the molecular chains, where after the Fe-containing oxide components are separated out from the suspension in a magnetic separation process.

According to a further embodiment, the mechanical energy can be introduced into the suspension in the form of ultrasonic pulses by means of one or more ultrasonic generators. According to a further embodiment, the ultrasonic pulses introduced may have an amplitude of at least 10 bar.

According to a further embodiment, the mechanical energy can be introduced by means of a grinding unit or an agitating unit, in which the suspension is ground or agitated. According to a further embodiment, the mechanically treated suspension can be introduced into a tubular reactor, the outside of which is provided with one or more magnets, which attract(s) the magnetizable particles and keep(s) them on the reactor wall, or by way of which the magnetizable particles are concentrated and sucked away. According to a further embodiment, a reactor with a number of magnets arranged one behind the other along its outer wall can be used, so that magnetic separation is performed at a number of locations along the reactor. According to a further embodiment, a reactor in which at least one, possibly further, ultrasonic generator is arranged between at least two magnets that are arranged one behind the other can be used.

According to another embodiment, an apparatus for carrying out one of the above mentioned methods may comprise a device for imparting mechanical action to the suspension containing the agglomerates to be worked, consisting of ore particles of value and magnetizable particles attached to said ore particles, especially Fe₃O₄, and containing an agent for breaking up hydrophobic molecular chain bonds between ore particles of value and the magnetizable particles that are exposed as a result of the mechanical action, is provided, as well as a device arranged downstream of the device for imparting mechanical action for magnetically separating the exposed magnetizable particles from the ore particles of value.

According to a further embodiment of the apparatus, the device for imparting mechanical action may comprise one or more ultrasonic generators for introducing ultrasonic pulses into the suspension. According to a further embodiment of the apparatus, the ultrasonic generators may generate pulses with an amplitude of at least 10 bar. According to a further embodiment of the apparatus, the device for imparting mechanical action may comprise a grinding unit or an agitating unit. According to a further embodiment of the apparatus, the separating device may comprise a tubular reactor, the outside of which is provided with one or more magnets, which attract(s) the magnetizable particles and keep(s) them on the reactor wall, or by way of which the magnetizable particles are concentrated and sucked away. According to a further embodiment of the apparatus, a number of magnets arranged one behind the other along the outer wall of the reactor can be provided, so that magnetic separation is performed at a number of locations along the reactor. According to a further embodiment of the apparatus, at least one, possibly further, ultrasonic generator can be arranged between at least two magnets that are arranged one behind the other.

### BRIEF DESCRIPTION OF THE DRAWINGS

Further advantages, features and details of the invention emerge from the exemplary embodiment described below and on the basis of the drawings, in which:

FIG. 1 shows a basic representation of an agglomerate, consisting of Cu₂S and Fe₃O₄ particles,

FIG. 2 shows a basic representation of an apparatus according to a first embodiment, and

FIG. 3 shows a basic representation of an apparatus according to a second embodiment.

### DETAILED DESCRIPTION

According to various embodiments, in the case of a method of the type mentioned at the beginning it is provided that the agglomerates are contained in a suspension containing a carrier fluid and are broken up by introducing mechanical energy, so that an agent that is contained in the suspension and breaks down the exposed, hydrophobically acting molecular chains can act on the molecular chains, whereafter the Fe-containing oxide components are separated out from the suspension in a magnetic process.

The method according to various embodiments provides a combination of the introduction of a high level of mechanical energy, the effect of one or more chemical agents and magnetic forces, in order on the one hand to bring about the breaking-up or disintegration of the agglomerates, and in order on the other hand to separate the ferromagnetic oxide components, that is to say for example the Fe₃O₄ particles, from the ore particles of value, that is to say for example the Cu₂S particles. The introduction of mechanical energy into the suspension, or the particles contained in the suspension, serves the purpose of breaking up the organic chain bonds, consequently therefore opening the Fe₃O₄ shell that inhibits the action on or the reaction of the chemical agent that is present in the suspension and breaks down the molecular chains. This has the effect that the agent can then terminate the hydrophobic action of the molecular chains, so that the Cu₂S particles and the Fe₃O₄ particles separate from one another, consequently therefore are separate and free. This then makes it possible to separate the ferromagnetic Fe particles out from the suspension by way of a downstream magnetic separation device. After the Fe-containing oxide component has been separated out, the only particles contained by the suspension are Cu₂S particles, since it is possible by means of a magnetic separation device to separate out virtually the entire Fe-containing oxide material, or at least up to a proportion of 98% thereof.

The method according to various embodiments can be used extremely efficiently, since the mechanical and chemical treatment ultimately take place at the same time because the agent breaking down the molecular chains is already obtained in the suspension when the latter has been mechanically treated. This means that the actual breaking-up process proceeds very quickly. The downstream magnetic separation then offers virtually complete separation of the types of particle to be separated.

According to one embodiment, the mechanical energy is preferably introduced into the suspension in the form of ultrasonic pulses by means of one or more ultrasonic generators. It is necessary to introduce ultrasonic pulses of extremely high power, which transport sufficient mechanical energy to the particles for them to be torn apart and for the chemical action on the hydrophobic layers or the hydrophobic molecular chains to be possible. The amplitude of the ultrasonic pulses introduced should be at least 10 bar, preferably however several 10s of bars; consequently therefore, high-intensity shockwaves can be produced by way of suitable converter systems. Electromagnetically driven flat coils or impulse-voltage-driven high-power piezo transducer arrays or underwater spark gaps or thermohydraulic transducers may be used for example as ultrasonic generators, consequently therefore systems which can generate high-intensity waves that are suitable for overcoming, even only briefly, the bonding forces between a Cu₂S particle and an oxide particle, that is to say for example a Fe₃O₄ particle, both of which are hydrophobized, and making the chemical action possible.

As an alternative to using one or more ultrasonic generators, but possibly also in addition, for example upstream, there is in principle the possibility of also introducing the mechanical energy by means of a grinding unit or an agitating unit, in which the suspension is ground using suitable grinding elements such as beads or the like or is agitated by introducing shearing forces to break up the particles. The grinding unit or the agitating unit should preferably operate continuously, that is to say such that it can be continuously charged with the particle-containing suspension and that the ground or agitated material can be continuously drawn off. Also conceivable in principle, however, is batch-mode operation, in which the grinding unit or agitating unit is therefore charged and the ground or agitated material is removed at the end of the respective operation, after which a renewed cycle begins. For the magnetic separation of the ferromagnetic oxide particles, according to various embodiments the mechanically treated suspension is introduced into a tubular reactor, the outside of which is provided with one or more magnets, which attract(s) the ferromagnetic oxide components and keep(s) them on the reactor wall, or by way of which the oxide components are attracted and sucked away.

According to the first alternative, in which the ferromagnetic particles are drawn onto the reactor wall and fixed there, discontinuous operation is realized, that is to say that the supply of suspension must be stopped in order to draw off the magnetic fixed Fe₃O₄ particles or the like. The second alternative, to be specific that of attracting and sucking away the magnetically separated particles, accordingly allows a continuous process in which the particles are constantly sucked away when a sufficient amount of particles has been deposited at the respective location.

It is at the same time expedient in principle within the course of the magnetic separation to use a reactor with a number of magnets arranged one behind the other along its outer wall, so that magnetic separation is performed at a number of locations along the reactor.

Furthermore, it may be expedient to use a reactor in which at least one, possibly further, ultrasonic generator is arranged between at least two magnets that are arranged one behind the other. If one or more ultrasonic generator or generators is or are used for the mechanical separation of the particles, it is advantageous to provide over the length of the reactor in the region of the magnetic separation one or more further ultrasonic generator or generators, which again introduce(s) mechanical energy in the form of high-intensity shockwaves into the suspension in the region of the magnetic separation. One reason for this is because renewed agglomerations can occur during the transporting of the particles that have already been mechanically treated once, unless complete breaking-up has occurred or unless the chemical agent has completely or sufficiently terminated the hydrophobic action of the molecular chains. If, therefore, according to various embodiments, the particles are subjected to mechanical action one or more times over the length of the magnetic separation zone, these remaining particles can also be broken up and the Cu₂S particles separated from the Fe₃O₄ particles by breaking down the molecular chains. In this case, a further ultrasonic generator is placed between two magnets arranged one behind the other and spaced apart from each other, so that the newly separated particles can then be directly separated by way of the magnets arranged downstream in the direction of flow.

But even if a grinding or agitating unit is used for the first mechanical separation, the use of such an ultrasonic generator in the region of the magnetic separation may be expedient, since there is in principle the possibility of remaining particles that are not yet separated, for whatever reason, being present there too.

Apart from the method, according to various embodiments of an apparatus for carrying out the method, the apparatus is distinguished by a device for imparting mechanical action to the suspensions containing the agglomerates to be worked, consisting of ore of value and Fe-containing oxide components enclosing said ore, especially Fe₃O₄, and containing an agent for terminating the hydrophobic action of hydrophobic molecular chains on the Cu₂S and the oxide components exposed as a result of the mechanical action, as well as by a device arranged downstream of the device for imparting mechanical action for magnetically separating the exposed oxide components from the Cu₂S particles.

The device for imparting mechanical action may in this case comprise one or more ultrasonic generators for introducing ultrasonic pulses into the suspension, ultrasonic generators that can generate high-intensity shockwave pulses with an amplitude of at least 10 bar, preferably several 10s of bars, being used. As an alternative to using ultrasonic generators, the use of a mechanical grinding unit or a mechanical agitating unit and combinations thereof is also conceivable.

The separating device itself expediently comprises a tubular reactor, the outside of which is provided with one or more magnets which attract(s) the oxide components and keep(s) them on the reactor wall, or by way of which the oxide components are attracted and then sucked away in a continuous working process. In this case, a number of magnets arranged one behind the other may be expediently provided along the outer wall of the reactor, so that magnetic separation can be performed at a number of locations along the reactor. In principle, there is also the possibility of arranging between the at least two magnets arranged one behind the other at least one, possibly further ultrasonic generator, in order also in the region of magnetic separation to impart mechanical action once again to any non-separated particles to bring about the separation thereof and subsequent reaction of the agent breaking down the chains.

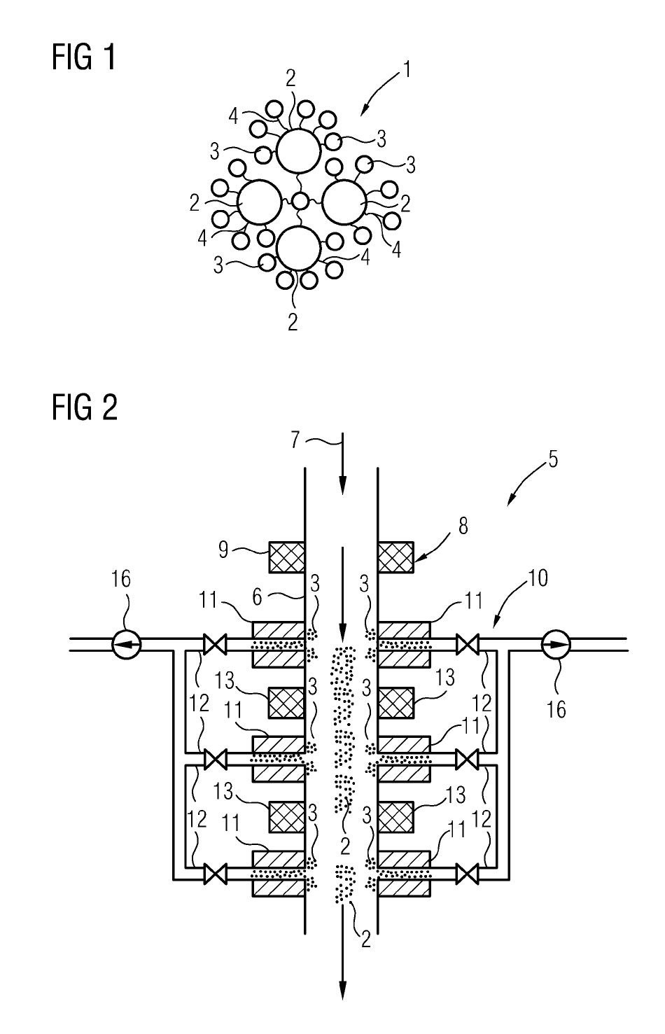

FIG. 1 shows in the form of a basic representation an agglomerate 1, consisting in the example shown of four Cu₂S particles 2 and, surrounding these, a multiplicity of ferromagnetic oxide components, here Fe₃O₄ particles 3, which are depicted as significantly smaller here for the sake of overall clarity. The Cu₂S particles 2 and the Fe₃O₄ particles 3 are bonded to one another by way of longer organic molecular chains 4. This organic chain material was added together with the powdered Fe₃O₄ to the ore that was finely ground and pre-cleaned at the beginning of the extraction process, in order to hydrophobize both the, non-magnetic, Cu₂S contained in the ground ore and the ferromagnetic Fe₃O₄ and in order to make it possible for Fe₃O₄ particles 3 to become attached to the Cu₂S particles 2, in order that these agglomerates can be magnetically separated out from the other ground ore material. It is then necessary to break up these agglomerates again and to separate the Cu₂S from the Fe₃O₄, which is intended to be used again for this upstream process. This takes place by simultaneously imparting mechanical and chemical action to the agglomerates 1 shown in FIG. 1, in order on the one hand to break up the agglomerates by introducing mechanical energy, that is to say to part or break up the molecular chains 4, and on the other hand to destroy by chemical reaction the bonds of the molecular chains that are then exposed as a result of the mechanical breakup.

FIG. 2 shows a basic representation of an apparatus 5 according to various embodiments for breaking up the agglomerates 1 and separating the Cu₂S particles 2 from the Fe₃O₄ particles 3. A suspension 7, which is to be mechanically, chemically and magnetically treated in a reactor 6 and is represented by the arrow, is introduced into the reactor 6. The suspension 7 consists of a carrier fluid, for example water, which contains the agglomerates 1 to be treated, as well as one or more chemical agents, which serve(s) the purpose of breaking up the organic molecular chains 4. NaOH and/or a surfactant may be used as such an agent, that is to say that in such cases the suspension is an NaOH solution and/or a surfactant solution.

Also provided is a device 8 in the form of an ultrasonic generator 9, which is arranged on the outside of the tubular reactor 6. The ultrasonic generator is designed for generating high-intensity shockwaves with amplitudes of several 10s of bars and serves the purpose of introducing mechanical energy into the suspension or agglomerates by way of these shockwaves, in order to mechanically open the agglomerates, that is, as it were, to tear them apart. The ultrasonic pulses are emitted in sufficiently rapid sequence to ensure that as many agglomerates 1 as possible can be broken up already at this point. The frequency of the shockwaves may possibly be chosen on the basis on the flow rate of the suspension 7.

As soon as the particles 1 of the suspension 7 have been mechanically treated and the agglomerates 1 broken up in this way, the chemical agent or agents of the suspension 7 can act on the organic molecular chains 4 and destroy their bonding force, so that ultimately the bonds produced by them between the Cu₂S particles and the Fe₃O₄ particles are parted. The Cu₂S particles 2 and the Fe₃O₄ particles 3 are consequently free and separate in the suspension 7.

Arranged downstream of the device 8 is a device 10 for magnetically separating the Fe₃O₄ particles 3 from the non-magnetic Cu₂S particles. In the example shown, the device 10 comprises a number of magnets 11 arranged along the tubular reactor 6, which may be any desired magnets, but preferably permanent magnets (electromagnetic coils would also be conceivable however), that are suitable for generating a magnetic field which acts on the Fe₃O₄ particles 3 located inside the reactor. The Fe₃O₄ particles are drawn onto the reactor wall by the magnets 11 (two of which may also be arranged lying opposite each other, for example, so that the field is built up through the tube). The magnets 11 are each configured in such a way that there is the possibility of sucking away the Fe₃O₄ particles 3 that have accumulated on the inner wall of the tube, for which purpose corresponding suction removal lines 12 and corresponding pumps 16 are provided. These suction removal lines 12 are used to suck away the Fe₃O₄ particles along with a small amount of suspension fluid and subsequently recover them, for example by drying. They can then be fed back to the initial treatment of the finely ground ore, in order to agglomerate once again in a state in which they are hydrophobized with Cu₂S particles to be separated out.

The Cu₂S particles 2 contained in the suspension remain in the reactor 6 and are drawn off at the end thereof. To recover them, they may also be subsequently dried or separated from the suspension fluid by other technical processes, such as for example hydrocyclones.

As FIG. 2 further shows, arranged respectively between two magnets 11 along the magnetic separation zone are further ultrasonic generators 13, which like the ultrasonic generator 9 are designed for generating high-intensity shockwaves. They serve the purpose of breaking up any agglomerates 1 that have not yet been separated by way of the first ultrasonic generator 9 in the region of the magnetic separation, so that there at the latest the chemical agents can break up the organic chains 4 and separate the last Cu₂S particles from the Fe₃O₄ particles. The agglomerates separated in these regions for the first time, or their then exposed Cu₂S particles 2 and Fe₃O₄ particles 3, are then separated at the respectively downstream magnet 11.

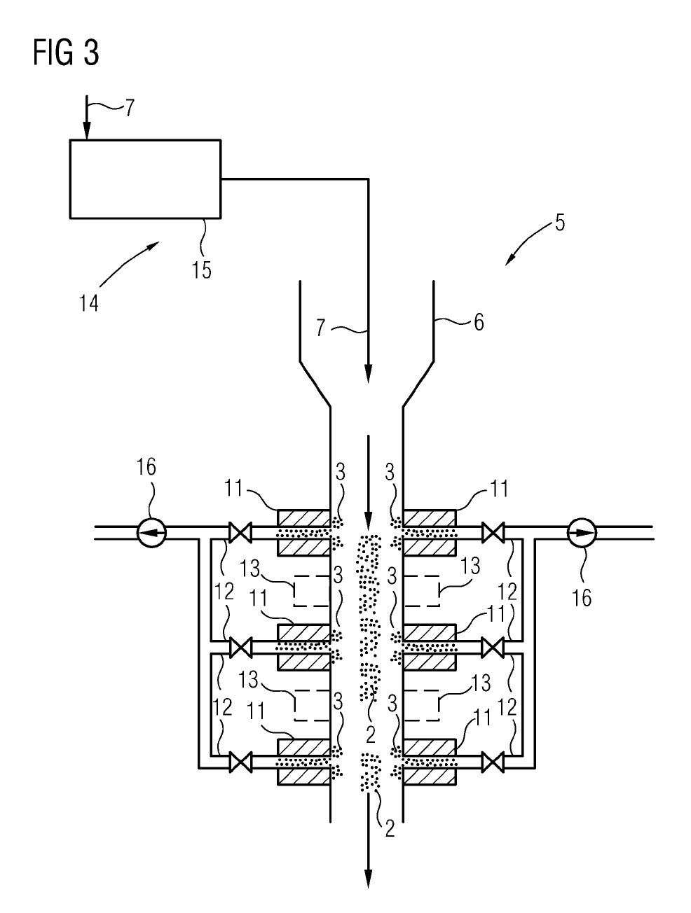

FIG. 3 shows a further embodiment of an apparatus 5, in respect of which the same components are provided with the same designations. Here, the suspension 7, containing agglomerates 1 as well as the corresponding chemical agent or agents, that is to say for example the NaOH solution or the surfactant solution, is first introduced into a device 14 for generating and introducing mechanical energy for the mechanical breaking-up of the agglomerates 1. In the example shown, this device is a grinding unit 15, in which the agglomerates 1 are, for example, broken up by means of suitable grinding beads or the like. The ground agglomerates 1 are then removed from the grinding unit 15, possibly together with the grinding beads, which directly thereafter are separated from the ground agglomerates or the suspension 7 and can thus be fed to the grinding unit 15 once again. The suspension 7 is then fed to the reactor 6. The latter is once again provided with the magnets 11, which in turn attract the Fe₃O₄ particles 3. Here, too, corresponding suction removal lines 12 along with pumps 16 are provided, by way of which the Fe₃O₄ particles 3 along with a small amount of suspension fluid can be drawn off and subsequently recovered, in order to be added to the ore powder ground at the beginning of the basic separation process. As indicated by dashed lines, here too there is the possibility of placing ultrasonic generators 13 of the type already described between two magnets 11 arranged spaced apart along the reactor 6, in order here too to separate any not yet separated agglomerates 1 or agglomerates which have possibly re-agglomerated. The Cu₂S particles 2 in the remaining suspension 7 are then drawn off with the suspension and finally separated from the suspension by way of downstream process technology.

What is claimed is:

1. A method for separating ore particles of value from agglomerates which contain ore particles of value and magnetizable particles attached thereto in the course of a process for extracting the ore of value from crude ore, within which agglomerates the ore particles of value and the magnetizable particles are bonded by way of organic molecular chains, that the method comprising:
containing the agglomerates in a suspension comprising a carrier fluid, and
breaking up the agglomerates by introducing mechanical energy, so that an agent within the suspension breaks down the exposed hydrophobically acting molecular chains can act on the molecular chains,
whereafter the Fe-containing oxide components are separated out from the suspension in a magnetic separation process.

2. The method according to claim 1, wherein the mechanical energy is introduced into the suspension in the form of ultrasonic pulses by means of one or more ultrasonic generators.

3. The method according to claim 2, wherein the ultrasonic pulses introduced have an amplitude of at least 10 bar.

4. The method according to claim 1, wherein the mechanical energy is introduced by means of a grinding unit or an agitating unit, in which the suspension is ground or agitated.

5. The method according to claim 1, the method further comprising:
introducing the mechanically treated suspension into a tubular reactor, the outside of which is provided with one or more magnets
attracting the magnetizable particles by means of said one or more magnets, and
keeping said magnetizable particles on the reactor wall by said one or more magnets.

6. The method according to claim 5, wherein a reactor with a number of magnets arranged one behind the other along its outer wall is used, so that magnetic separation is performed at a number of locations along the reactor.

7. The method according to claim 6, wherein a reactor in which at least one ultrasonic generator is arranged between at least two magnets that are arranged one behind the other is used.

8. An apparatus for separating ore particles of value from agglomerates, comprising:
a device for imparting mechanical action to a suspension containing the agglomerates to be worked, wherein the suspension comprises ore particles of value and magnetizable particles attached to said ore particles and an agent for breaking up hydrophobic molecular chain bonds between ore particles of value and the magnetizable particles that are exposed as a result of the mechanical action, and
a device arranged downstream of the device for imparting mechanical action for magnetically separating the exposed magnetizable particles from the ore particles of value.

9. The apparatus according to claim 8, wherein the device for imparting mechanical action comprises one or more ultrasonic generators for introducing ultrasonic pulses into the suspension.

10. The apparatus according to claim 9, wherein the ultrasonic generators generate pulses with an amplitude of at least 10 bar.

11. The apparatus according to claim 8, wherein the device for imparting mechanical action comprises a grinding unit or an agitating unit.

12. The apparatus according to claim 8, wherein the separating device comprises a tubular reactor, the outside of which is provided with one or more magnets, which are operable to attract the magnetizable particles and to keep them on the reactor wall.

13. The apparatus according to claim 12, wherein a number of magnets arranged one behind the other along the outer wall of the reactor are provided, so that magnetic separation is performed at a number of locations along the reactor.

14. The apparatus according to claim 13, wherein at least one ultrasonic generator is arranged between at least two magnets that are arranged one behind the other.

15. The apparatus according to claim 8, wherein the separating device comprises a tubular reactor, the outside of which is provided with one or more magnets, which are operable to concentrate the magnetizable particles and wherein the tubular reactor is further operable to suck away said concentrated magnetizable particles.

16. The apparatus according to claim 8, wherein the magnetizable particles are Fe₃O₄.

17. The apparatus according to claim 8, wherein the device for imparting mechanical action comprises one or more ultrasonic generators for introducing ultrasonic pulses into the suspension, and
wherein the separating device comprises a tubular reactor, the outside of which is provided with one or more magnets, which are operable to attract the magnetizable particles and to keep them on the reactor wall, wherein the tubular reactor further comprises a number of magnets arranged one behind the other along the outer wall of the reactor, so that magnetic separation is performed at a number of locations along the reactor and at least one further ultrasonic generator arranged between at least two magnets that are arranged one behind the other.

18. The method according to claim 1, wherein the method further comprises
introducing the mechanically treated suspension into a tubular reactor, the outside of which is provided with one or more magnets;
concentrate the magnetizable particles by means of said one or more magnets, and
sucking away said concentrated magnetizable particles.

19. The method according to claim 1, wherein the magnetizable particles are Fe₃O₄.

20. The method according to claim 1, wherein the mechanical energy is introduced into the suspension in the form of ultrasonic pulses by means of one or more ultrasonic generators, the method further comprising:
introducing the mechanically treated suspension into a tubular reactor, wherein the tubular reactor comprises a number of magnets arranged one behind the other along its outer wall, so that magnetic separation is performed at a number of locations along the reactor, wherein the reactor further comprises at least one further ultrasonic generator arranged between at least two magnets that are arranged one behind the other,
attracting the magnetizable particles by means of said magnets.
